(19) United States
(12) Patent Application Publication
(10) Pub. No.: US 2005/0068318 A1
(43) Pub. Date: Mar. 31, 2005

(54) METHOD FOR CALCULATING ATTRIBUTES OF A 3-D GRAPHIC

(76) Inventor: Eric Chuang, Taipei Hsien (TW)

Correspondence Address: (NAIPC) NORTH AMERICA INTERNATIONAL PATENT OFFICE, P.O. BOX 506, MERRIFIELD, VA, 22116, US

(21) Appl. No.: 10/709,400

(22) Filed: May 3, 2004

(30) Foreign Application Priority Data
Sep. 25, 2003 (TW) 092126535

(51) Int. Cl. G06T 15/40

(52) U.S. Cl. 345/421

(57) ABSTRACT

A method for calculating attributes of a 3-D graphic with a vertex shader. The 3-D graphic includes a plurality of triangular primitives, each of which contains three vertexes and each of the vertexes having a plurality of attributes including position attributes. The method includes calculating a triangular transform and related position attributes corresponding to the triangular primitive with a transform program consisting of a couple of instructions of the vertex shader, determining whether the triangular transform is visible or not according to the position attributes of three vertexes of the triangular transform, and calculating remaining attributes of the triangular transform if the triangular transform is visible or not calculating the remaining attributes of the triangular transform and culling the triangular transform if the triangular transform is invisible.

### BACKGROUND OF INVENTION

1. Field of the Invention

The present invention relates to a method for calculating attributes of a 3-D pattern having a plurality of vertexes, and more particularly, to a method for calculating attributes of the vertexes of the 3-D graphic with a vertex shader.

2. Description of the Prior Art

In recent years, a software-formed vertex shader such as DirectX 8 produced by Microsoft, as well as a hardware-formed vertex shader embedded into a graphic chip such as GeForce 3 produced by NVIDIA and Radeon chip made by ATI, has become one of the most dominant programs to process a 3-D pattern. A vertex shader is used mainly on transform & lighting (T&L).

A 3-D pattern can be seemed to be made up of a plurality of triangles. When a game program transfers a 3-D pattern displayed on a computer monitor to a graphic chip (or to a software vertex shader) for T&L processing, what the game program actually transfers is vertex information, that is attributes, about the plurality of triangles of the 3-D pattern. According to vertex shader standard, each of the vertexes of the 3-D pattern has 16 attributes, three position attributes respectively representing x-, y-, and z-coordinates of a place that the vertex stays on in space, a weighing attribute (w), four color attributes respectively in formats of r (red), g (green), b (blue), and a (alpha) sequentially for indicating what colors the vertex shows in an environment of a spotlight or a scattering light, a normal vector attribute perpendicular to a triangle that the vertex stays on, four texture coordinate attributes s, t, r and q respectively representing what position the vertex stays on according to a certain texture, diffusion coordinate attributes, and a variety of attributes relating the size of the vertex, etc.

Each of the attributes of the vertex processed by the vertex shader has a format of a floating number of 4×32 bits. The vertex shader processes these floating numbers in a single instruction multiple data (SIMD) manner and accesses and processes a 4×4 (calculating x, y, z and w or r, g, b and a at the same time) or a 3×3 (calculating x, y and z or r, g and b at the same time) matrix-formed data with 12 embedded SIMD registers simultaneously. Therefore, data contained in a vertex of a triangle in a 3-D pattern displayed on a computer monitor is dramatically huge.

As described previously, since each of the vertexes of the 3-D pattern has 16 attributes and each of the attributes has a data capacity of 4×32 bits, information contained in any of the vertexes is very huge. The vertex shader needs only to take the coordinates of a viewing point corresponding to a triangular primitive into consideration in executing the transform calculation of the T&L of the triangular transform, for example changing the coordinates of the three vertexes of the triangular primitive by rotating, enlarging/reducing, or moving the triangular primitive toward a predetermined direction according to the coordinate of the viewing point. On the other hand, the vertex shader has to take care of not only the coordinates of the viewing point in executing the light of the T&L, but also the vertex shader has to consider a variety of factors such as how many light sources are shining on the triangular primitive and types of the light sources (for example singular light source, omni-directional light source and projection light source). Therefore, time for the vertex shader to execute the lighting of the T&L is far longer than that to execute the transform of the T&L. For example, an inner product calculation in the transform of the T&L takes two periods, while a calculation for seventeen singular light sources in the light of the T&L takes as long as 126 periods.

### SUMMARY OF INVENTION

It is therefore a primary objective of the claimed invention to provide a method for calculating attributes of vertexes of a three-dimensional pattern with a vertex shader to overcome the drawback of the prior art.

According to the claimed invention, the method is capable of calculating attributes of vertexes of a three-dimensional pattern having a plurality of triangular primitives with a vertex shader, each of the triangular primitives having three vertexes, and each of the vertexes comprising a plurality of attributes. The method includes calculating a triangular transform and related position attributes corresponding to a triangular primitive with a transform program consisting of a couple of instructions among a plurality of instructions of the vertex shader, determining whether the triangular transform is visible according to the position attributes of the triangular transform, and calculating remaining attributes of the triangular transform if the triangular transform is visible or not calculating the remaining attributes of the triangular transform and culling the triangular transform if the triangular transform is invisible.

It is an advantage of the claimed invention that the method calculates the attributes of a visible triangular transform only and omits a plurality of light calculations of a triangular transform if the triangular transform is invisible.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic diagram showing that a vertex shader transforming an original 3-D pattern into a transformed 3-D pattern according to the present invention.

FIG. 2 is a flow diagram of a method of the preferred embodiment according to the present invention.

### DETAILED DESCRIPTION

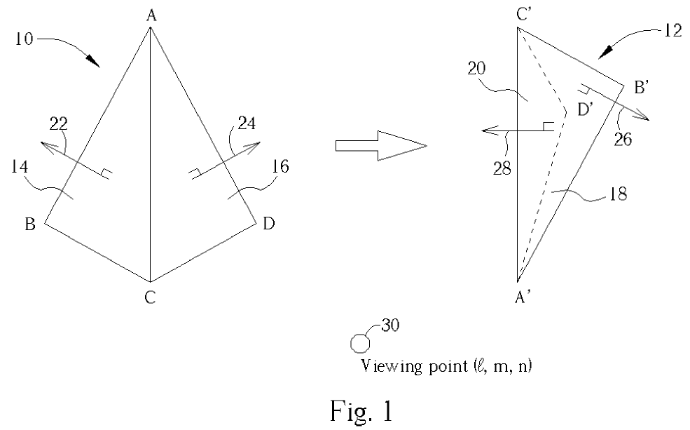

Please refer to FIG. 1, which is a schematic diagram showing that a vertex shader transforming an original 3-D pattern 10 into a transformed 3-D pattern 12 according to the present invention. The original 3-D pattern 10 comprises two triangular primitives 14 and 16, and the transformed 3-D pattern 12 comprises two triangular transforms 18 and 20. The triangular primitives 14 and 16 and the triangular transform 18 are visible and have normal vertexes 22, 24 and 26 directing outward, while the triangular transform 20 is covered by the triangular 18 and is invisible and has a normal vertex 28 directing inward. Therefore, since the triangular transform 20 has been transformed to be a triangle back to a viewpoint 30 in the 3-D pattern transformation process for transforming the original 3-D pattern 10 into the transformed 3-D pattern 12 and the viewpoint 30 can see all of the triangles other than the triangular transform 20 of the transformed 3-D pattern 12, the calculation of texture coordinate attributes and diffusion coordinate attributes of the angular transform 20 are of no significance. In conclusion, the vertex shader can ignore a triangular transform whose normal vertex is directing inward and only needs to calculate all of the attributes of a visible triangular transform (for example, the triangular transform 18).

The method for executing the vertex shader of the present invention calculates coordinate attributes of three vertexes of a triangular transform transformed from a triangular primitive of the original 3-D pattern 10 and calculates the remaining attributes of the triangular transform by determining whether the triangular transform is visible. In other words, if the triangular transform is invisible and cannot be seen from the viewpoint 30, the vertex shader ignores the triangular transform without calculating the remaining attributes any further. On the contrary, if the triangular transform has a normal vertex directing outward and is visible, the vertex shader continues calculating the remaining attributes of the three vertexes of the triangular transform, such as the texture coordinate attributes s, t, r and q, color attributes r, g, b and a, and diffusion coordinate attributes, etc.

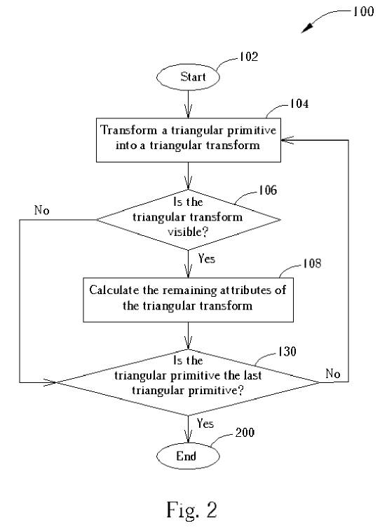

Please refer to FIG. 2, which is a flow diagram of a method 100 of the preferred embodiment according to the present invention. The method comprises following steps:
Step 102: start;
(The original 3-D pattern 10 is about to be transformed into the transformed 3-D pattern 12.)
Step 104: transforming three vertex primitives of a triangular primitive of the original 3-D pattern 10 into three vertex transforms of a triangular transform with a transform program consisting of a couple of instructions among a plurality of instructions of the vertex shader;
Step 106: determining whether the triangular transform is visible. if the triangular transform is visible, then go to step 108, else cull the triangular transform and go to step 130;
Step 108: calculating the remaining attributes of the triangular transform;
Step 130: determining whether the triangular primitive the triangular transform being transformed from is the last triangular primitive of the original 3-D pattern 10. if so, go to step 200, else go to step 104; and
(keeps calculating the attributes until all of the triangular primitives of the original 3-D pattern 10 have been transformed.)
Step 200: end.

In step 106 of the method 100, whether the triangular transform is visible can be determined by a discriminant

$$[ \begin{matrix}{x}_{1} - {x}_{0} & {x}_{2} - {x}_{0} \\ {y}_{1} - {y}_{0} & {y}_{2} - {y}_{0}\end{matrix} ] ,$$

, wherein (x₀,y₀), (x₁, y₁) and (x₂, y₂) are coordinates of three vertexes of the triangular transform. Whether a positive or a negative discriminant corresponds to a visible triangular transform can be determined by an application program (AP) and by determining whether the normal vertex of the triangular transform is directed outward or inward. For example, after determining a triangular transform A′B′C′ is visible and a triangular transform A′D′C′ is invisible, the vertex shader of the present invention culls the triangular transform A′D′C′ from the transformed 3-D pattern 12 and continues calculating the remaining attributes of three vertexes of the triangular transform A′B′C′.

In contrast to the prior art, the present invention can provide a method for calculating attributes of a 3-D pattern with a vertex shader. The method calculates the three vertexes of the triangular transform according to the three vertexes of a triangular primitive first, determines whether the triangular transform is visible, and calculates the remaining attributes of the triangular transform if the triangular transform is visible or culls the triangular transform and omits the light calculation of T&L if the triangular transform is invisible and cannot be seen from the viewing point 30. As mentioned previously, since the light calculating of the T&L is far more complicated than the transform calculation of the T&L, the method of the prevent invention has a plurality of light calculation omitted and promotes the efficiency of a processor to execute a game program for example.

Following the detailed description of the present invention above, those skilled in the art will readily observe that numerous modifications and alterations of the device may be made while retaining the teachings of the invention. Accordingly, the above disclosure should be construed as limited only by the metes and bounds of the appended claims.

1. A method for calculating attributes of vertexes of a three-dimensional pattern having a plurality of triangular primitives with a vertex shader, each of the triangular primitives having three vertexes, each of the vertexes comprising a plurality of attributes, and the method comprising:
calculating a triangular transform and related position attributes corresponding to a triangular primitive with a transform program consisting of a couple of instructions among a plurality of instructions of the vertex shader;
determining whether the triangular transform is visible according to the position attributes of the triangular transform; and
calculating remaining attributes of the triangular transform if the triangular transform is visible or not calculating the remaining attributes of the triangular transform and culling the triangular transform if the triangular transform is invisible.

2. The method of claim 1, wherein whether the triangular transform is visible is determined by determining whether a discriminant
$$[ \begin{matrix}{x}_{1} - {x}_{0} & {x}_{2} - {x}_{0} \\ {y}_{1} - {y}_{0} & {y}_{2} - {y}_{0}\end{matrix} ]$$
is positive, x₀, x₁ and x₂ being x-coordinates of the position attributes of the three vertexes of the triangular transform respectively, and y₀, y₁ and y₂ being y-coordinates of the position attributes of the three vertexes of the triangular transform respectively.

3. The method of claim 1, wherein whether the triangular transform is visible is determined by determining whether a normal vector of the triangular transform is pointing outward.

4. The method of claim 1, wherein the remaining attributes of the triangular transform are calculated with a lighting program.

5. The method of claim 4, wherein the triangular transform has three vertexes, each of the three vertexes comprising at least a color attribute, and the light program is used for calculating the color attributes.

6. The method of claim 5, wherein each of the vertexes comprises four color attributes.

7. The method of claim 6, wherein the four color attributes are red, green, blue, and alpha attributes respectively.

8. The method of claim 4, wherein the triangular transform has three vertexes, each of the vertexes comprising four texture attributes, and the lighting program is used for calculating the texture attributes.

9. The method of claim 1, wherein each of the vertexes comprises 16 attributes.

10. The method of claim 1, wherein each of the attributes of the vertexes has a data capacity of 4×32 bits.
